(19) United States
(12) Patent Application Publication
(10) Pub. No.: US 2006/0277303 A1
(43) Pub. Date: Dec. 7, 2006

(54) Method to improve response time when clients use network services

(76) Inventors: Nikhil Hegde, Austin, TX (US); Vinit Jain, Austin, TX (US); Rashmi Narasimhan, Austin, TX (US); Vasu Vallabhaneni, Austin, TX (US)

Correspondence Address: IBM CORP (YA);C/O YEE & ASSOCIATES PC, P.O. BOX 802333, DALLAS, TX, 75380, US

(21) Appl. No.: 11/146,472

(22) Filed: Jun. 6, 2005

(51) Int. Cl. G06F 15/173

(52) U.S. Cl. 709/226

(57) ABSTRACT

A method, apparatus, and computer program product in a data processing system for improving response time when clients use network services. If a load level exceeds a load transfer level, the method causes the server to refuse a corresponding percentage of incoming requests received. Then the method sends a message to the requesting client for each refused incoming request, wherein the message requests the requesting client to resend the refused incoming request to a secondary server.

### BACKGROUND OF THE INVENTION

1. Field of the Invention

The present invention relates generally to an improved data processing system and, in particular, to a method, system and computer program product for optimizing performance in a data processing system. Still more particularly, the present invention provides a method, system, and computer program product for improving response time when clients use network services.

2. Description of the Related Art

A server is a program which provides some services to other (client) programs. The connection between client and server is normally by means of message passing, often over a network. Networks are hardware and software data communication systems, such as the Internet, Ethernet, BITNET, Novell, and PSTN. Networks often use some protocol to encode the client's requests and the server's responses. There are many servers associated with the Internet, such as those for HTTP, Network File System, Network Information Service (NIS), Domain Name Service (DNS), FTP, news, finger, and Network Time Protocol.

Therefore, a network service is work performed (or offered) by a network server. This may mean serving simple requests for data to be sent or stored (as with file servers, gopher or http servers, e-mail servers, finger servers, SQL servers, etc.); or it may be more complex work, such as that of irc servers, print servers, X Windows servers, or process servers.

Most network services, such as a domain name service (DNS), have fail-over mechanisms to report host server errors to the client. The DNS is used to resolve, or translate, the name of an Internet host into a numerical Internet Protocol (IP) address and vice versa. Because many Internet-based applications need this domain name service, it is common for multiple servers to be used for redundancy. For example, the /etc/resolv.conf file can contain a maximum of three nameserver entries, whereby the local resolver routines either use a local name resolution database maintained in /etc/hosts for resolving a name to an IP address or vice versa, or the local resolver routines use the DNS protocol to request name/IP address resolution services from a remote DNS server.

Typically, in redundant systems the contact order of servers is the same for all clients in a network. Hence, all clients contact the same server first, such as the server at the top of the list. Due to the manner in which redundancy is configured, the secondary server is contacted only if no response is available from the primary server within a certain timeframe. Increasing Internet traffic leads to a proportional increase in the traffic to the primary server. It is not uncommon for the load-share between the primary server and the secondary server to be grossly imbalanced. Such an imbalance delays response time when clients use network services.

Furthermore, clients that communicate to network services with user datagram protocol (UDP) do not have a mechanism to know whether the server contacted is busy, the packet is dropped, or etc.

Therefore, it would be advantageous to have an improved method, system, and computer program product for improving response time when clients use network services.

### SUMMARY OF THE INVENTION

The present invention provides a method, system, and computer program product in a data processing system for improving response time when clients use network services. This is achieved by allowing the application server, such as a Domain Name Server or a File Transfer Protocol, to have control over what message is sent to the client when the kernel has to drop the packet sent by the client due to various reasons. For example, kernel may drop the packet because the receive buffer is full or based on a trigger which is set by the application using system call setsockopt, such as the receive buffer is 90% full. Then the kernel sends an error message for a port unreachable until the receive buffer level drops to 50% full.

If a load level exceeds a load transfer level, the method causes the server to refuse a corresponding percentage of incoming requests received. Then the method sends a message to the requesting client for each refused incoming request, wherein the message requests the requesting client to resend the refused incoming request to a secondary server.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which the present invention may be implemented, according to a preferred embodiment of the present invention;

FIG. 2 is a block diagram of a data processing system that may be implemented as a server in which the present invention may be implemented, according to a preferred embodiment of the present invention;

FIG. 3 is a block diagram illustrating a data processing system in which the present invention may be implemented, according to a preferred embodiment of the present invention;

FIG. 4 is a block diagram of the process for improving response time when clients use network services, according to a preferred embodiment of the present invention;

FIG. 5 is a block diagram of an algorithm for improving response time when clients use network services, according to a preferred embodiment of the present invention; and

FIG. 6 is a block diagram of another algorithm for improving response time when clients use network services, according to a preferred embodiment of the present invention.

### DETAILED DESCRIPTION OF THE PREFERRED EMBODIMENT

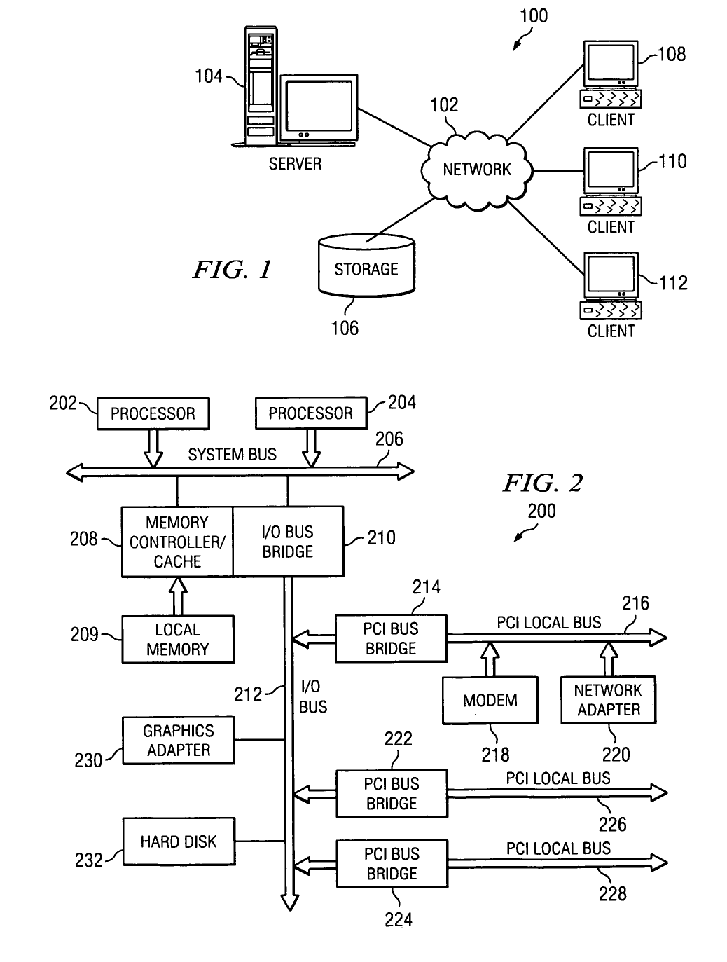

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eserver pSeries system, a product of International Business Machines Corporation in Armonk, N.Y., running the Advanced Interactive Executive (AIX) operating system or the LINUX operating system.

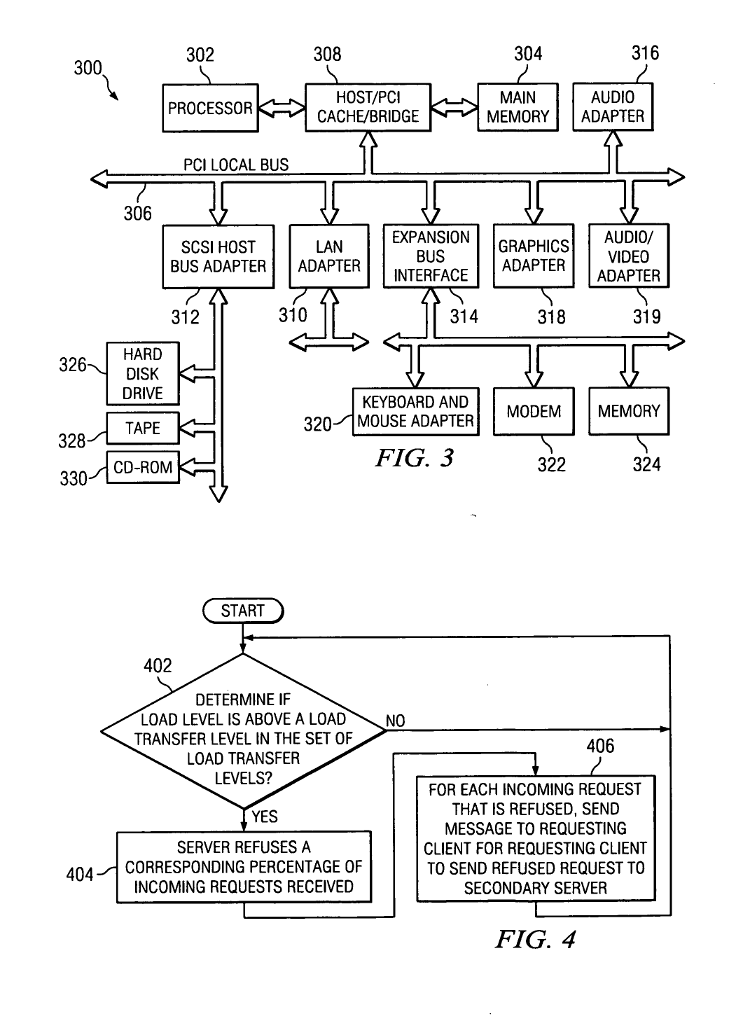

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory,for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention is a method, system and computer program product for improving response time when clients use network services. The mechanism of the present invention may be executed on a server, such as server 104 in FIG. 1, communicating through a network, such as network 102, with clients, such as client 108, client 110, and client 112. As an example of the preferred embodiment for the present invention, network servers have an additional socket option, such as a set of load transfer levels, wherein the set of load transfer levels includes one or more load transfer levels. This option is settable via a setsockopt( ) routine.

FIG. 4 is a block diagram of the process for improving response time when clients use network services, according to a preferred embodiment of the present invention. A determination is made whether a load level, such as the incoming requests buffer size, is above a selectable load transfer level in the set of selectable load transfer levels, as shown in step 402. If the load level, such as the incoming requests buffer size, is above a selectable load transfer level in the set of selectable load transfer levels, the server will start refusing a corresponding percentage of incoming requests received, as shown in step 404. The mechanism of the present invention selects the selectable load transfer levels in the set of selectable load transfer levels. The selectable load transfer level determines what percentage of incoming requests the server refuses and what percentage of incoming requests the server processes, based on a simple algorithm, discussed below. The algorithm leads to a more gradual off-loading of data to the server next in line.

When an incoming request is refused, the mechanism of the present invention sends a message to the requesting client for the requesting client to send the refused incoming request to a secondary server, as shown in step 406. These messages are different for clients that use transmission control protocol (TCP) and user datagram protocol (UDP). In the case of TCP connections, the mechanism of the present invention sends a RESET message back to the client. In the case of UDP connections, the mechanism of the present invention sends an “ICMP unreachable” message back to the client. After the requesting client receives the appropriate message, the requesting client sends the refused incoming request to the secondary server, thus effectively transferring part of the load from the primary server to the secondary server. After sending the message to the requesting client,the mechanism of the present invention returns to the step that determines whether a load level exceeds a load transfer level in the set of load transfer levels.

The mechanism of the present invention selects the selectable load transfer levels in the set of selectable load transfer levels. The mechanism of the present invention also selects the action to be taken when a load level is above a selectable load transfer level in the set of selectable load transfer levels, such as sending an “ICMP unreachable” message to the client, sending a RESET message to the client, or sending a message to the client requesting that the client resend the refused incoming request at a later time.

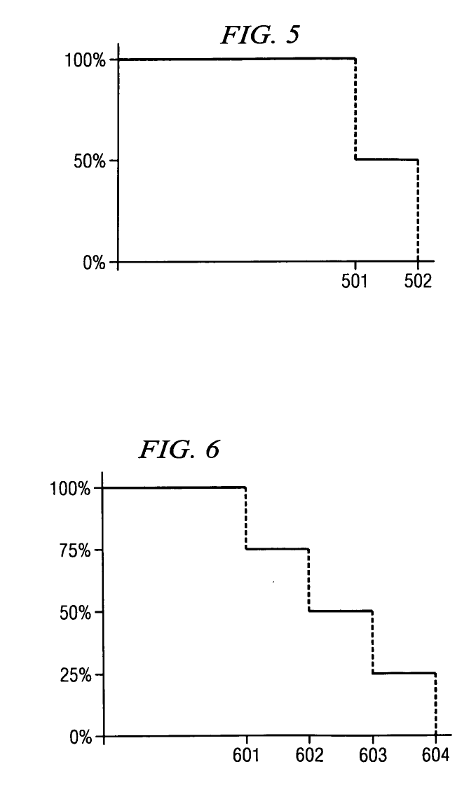

Turning now to FIG. 5, a block diagram illustrating the algorithm used in the method to improve response time when clients use network services, in accordance with a preferred embodiment of the present invention is shown. This method may be executed on a data processing system, such as data processing system 300 in FIG. 3. The simple gradient algorithm illustrated is an example of an algorithm that may be used to decide which incoming requests should be refused. In FIG. 5 the vertical axis depicts 0%, 50%, and 100%, which represents the possibility that an incoming request will be processed. The horizontal axis represents the load level, including selectable load transfer level 501 in a set of selectable load transfer levels and the maximum load level 502, such as maximum incoming request buffer size. When the load level is above selectable load transfer level 501, 50% of all incoming requests (every other incoming request) will be processed while 50% of all incoming requests (every other incoming request) will be refused. This mode of handling incoming requests continues until the load level either drops below selectable load transfer level 501 or the load level is above the maximum load level 502, such as the maximum incoming request buffer size. When the load level drops below selectable load transfer level 501, 100% of all incoming requests (every incoming request) will be processed while 0% of all incoming requests (no incoming request) will be refused. When the load level is above the maximum load level 502, such as maximum incoming request buffer size, 0% of all incoming requests (no incoming request) will be processed while 100% of all incoming requests (every incoming request) will be refused.

Of course, the logic from this example may be extended to have 4, 8, or 16 levels, and so on. For example, FIG. 6 depicts a similar algorithm in a scheme with 4 levels. 3 out of 4 incoming requests (75%) will be processed while 1 out of 4 incoming requests will be refused when the load level is above the first selectable load transfer level 601. 2 out of 4 incoming requests (50%) will be processed while 2 out of 4 incoming requests will be refused when the load level is above the second selectable load transfer level 602. 1 out of 4 incoming requests (25%) will be processed while 3 out of 4 incoming requests will be refused when the load level is above the third selectable load transfer level 603. 0 out of 4 incoming requests (0%) will be processed while 4 out of 4 incoming requests will be refused when the load level is above the fourth load transfer level 604, the maximum incoming request buffer size. The ideal algorithm would transfer loads at a smooth gradient, but this is very impractical in a real system.

During the process for improving response time when clients use network services, according to a preferred embodiment of the present invention, the determination that is made whether a load level exceeds a selectable load transfer level in the set of selectable load transfer levels may be made for any of a variety of load level indicators. The load level indicator based upon the incoming requests buffer size has been discussed above. A load level indicator that may be monitored is a set of the round trip times (RTT), a measure of the current delay on a network, wherein the set of round trip times includes a round trip time for each incoming request, or a subset of each incoming request. Another load level indicator that may be monitored is the amount of data in the send buffer. If the send buffer fills, then the server will be unable to respond to incoming requests.

The advantages provided by the mechanism of the present invention include the following factors. The same redundancy feature for servers is extended to balance loads across the servers. The response time for a network service is improved significantly. The handoff of a load to the next server is gradual. The incoming request buffer size and the send buffer size reflect the real capacity of the servers and are not limited for the sake of load sharing. Therefore, the method of the present invention, described above, improves response time when clients use network services.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for improving response time when clients use network services, the method comprising:
determining if a load level exceeds a load transfer level in a set of load transfer levels;
responsive to determining that the load level exceeds the load transfer level in the set of load transfer levels, refusing a corresponding percentage of a plurality of incoming requests received; and
responsive to refusing the corresponding percentage of the plurality of incoming requests received, sending a message to a requesting client for each incoming request that is refused, wherein the message requests the requesting client to resend the refused incoming request to a secondary server.

2. The method of claim 1, wherein the load level is based upon an incoming requests buffer size.

3. The method of claim 1, wherein the load level is based upon a set of round trip times including a round trip time for each incoming request.

4. The method of claim 1, wherein the load level is based upon an amount of data in a send buffer.

5. The method of claim 1, wherein the message sent to the requesting client using a user datagram protocol connection is “ICMP unreachable”.

6. The method of claim 1, wherein the message sent to the requesting client using a transmission control protocol connection is “RESET”.

7. The method of claim 1, wherein the message sent to the requesting client requests that the requesting client resend the refused incoming request at a later time.

8. A data processing system for improving response time when clients use network services, the data processing system comprising:
determining means for determining if a load level exceeds a load transfer level in a set of load transfer levels;
responsive to determining that the load level exceeds the load transfer level in the set of load transfer levels, refusing means for refusing a corresponding percentage of a plurality of incoming requests received; and
responsive to refusing the corresponding percentage of the plurality of incoming requests received, sending means for sending a message to a requesting client for each incoming request that is refused, wherein the message requests the requesting client to resend the refused incoming request to a secondary server.

9. The data processing system of claim 8, wherein the load level is based upon an incoming requests buffer size.

10. The data processing system of claim 8, wherein the load level is based upon a set of round trip times including a round trip time for each incoming request.

11. The data processing system of claim 8, wherein the load level is based upon an amount of data in a send buffer.

12. The data processing system of claim 8, wherein the message sent to a requesting client using a user datagram protocol connection is “ICMP unreachable”.

13. The data processing system of claim 8, wherein the message sent to the requesting client using a transmission control protocol connection is “RESET”.

14. The data processing system of claim 8, wherein the message sent to the requesting client requests that the requesting client resend the refused incoming request at a later time.

15. A computer program product on a computer-readable medium for use in a data processing system for improving response time when clients use network services, the computer program product comprising:
first instructions for determining if a load level exceeds a load transfer level in a set of load transfer levels;
responsive to determining that the load level exceeds the load transfer level in the set of load transfer levels, second instructions for refusing a corresponding percentage of a plurality of incoming requests received; and
responsive to refusing the corresponding percentage of the plurality of incoming requests received, third instructions for sending a message to a requesting client for each incoming request that is refused, wherein the message requests the requesting client to resend the refused incoming request to a secondary server.

16. The computer program product of claim 15, wherein the load level is based upon an incoming requests buffer size.

17. The computer program product of claim 15, wherein the load level is based upon a set of round trip times including a round trip time for each incoming request.

18. The computer program product of claim 15, wherein the load level is based upon an amount of data in a send buffer.

19. The computer program product of claim 15, wherein the message sent to the requesting client using a user datagram protocol connection is “ICMP unreachable”.

20. The computer program product of claim 15, wherein the message sent to the requesting client using a transmission control protocol connection is “RESET”.
